(19) United States
(12) Patent Application Publication
(10) Pub. No.: US 2017/0178806 A1
(43) Pub. Date: Jun. 22, 2017

(54) PERMANENT MAGNET, PERMANENT MAGNET MANUFACTURING METHOD, SPM MOTOR, AND SPM MOTOR MANUFACTURING METHOD

(71) Applicant: NITTO DENKO CORPORATION, Ibaraki-shi, Osaka (JP)

(72) Inventors: Keisuke TAIHAKU, Ibaraki-shi, Osaka (JP); Katsuya KUME, Ibaraki-shi, Osaka (JP); Toshiaki OKUNO, Ibaraki-shi, Osaka (JP); Izumi OZEKI, Ibaraki-shi, Osaka (JP); Tomohiro OMURE, Ibaraki-shi, Osaka (JP); Takashi OZAKI, Ibaraki-shi, Osaka (JP); Takashi YAMAMOTO, Ibaraki-shi, Osaka (JP)

(73) Assignee: NITTO DENKO CORPORATION, Ibaraki-shi, Osaka (JP)

(21) Appl. No.: 15/118,140

(22) PCT Filed: Feb. 12, 2014
(86) PCT No.: PCT/JP2014/053115

§ 371 Date: Aug. 11, 2016

(51) Int. Cl. H01F 41/02; H02K 1/27; B22F 3/10; C22C 38/00; B22F 9/04; B22F 3/16; H02K 15/03; H01F 7/02

(52) U.S. Cl. CPC H01F 41/0266; H02K 15/03; H02K 1/27; H01F 7/02; C22C 38/005; C22C 38/002; B22F 9/04; B22F 3/16; B22F 3/1017; B22F 2998/10; B22F 2301/355; B22F 2009/041; B22F 2202/05; B22F 2302/45; B22F 2303/40

(57) ABSTRACT

Provided are: a permanent magnet wherein the magnetic field orientation process can be made simple and a degree of orientation thereof can be improved; a method for manufacturing a permanent magnet, an SPM motor using a permanent magnet, and a method for manufacturing an SPM motor. Raw material magnet is milled to magnet powder, and the magnet powder is mixed with a binder to form a compound. Then, the compound is molded by hot-melt molding to a green sheet in a shape of a sheet onto a supporting substrate. Thereafter, a magnetic field is applied to the green sheet thus molded to carry out magnetic field orientation. Further, with fixing plural green sheets after the magnetic field orientation by lamination under a deformed state thereof, the plural green sheets thus laminated are cut for shaping to a prescribed shape, which is followed by sintering to produce a permanent magnet.

### TECHNICAL FIELD

The present invention relates to a permanent magnet, a method for manufacturing a permanent magnet, an SPM motor using a permanent magnet, and a method for manufacturing an SPM motor.

### BACKGROUND ART

In recent years, a decrease in size and weight, an increase in power output, and an increase in efficiency have been needed in a permanent magnet motor used in a hybrid car, a hard disk drive, and so forth. To realize such a decrease in size and weight, an increase in power output, an increase in efficiency, and a reduction in torque ripple in the permanent magnet motor mentioned above, film-thinning and a further improvement in magnetic properties have been needed for a permanent magnet to be embedded in the motor.

As to a method for manufacturing a permanent magnet to be used in a permanent magnet motor, a powder sintering method has been generally used. In this powder sintering method, first, a raw material is milled by a jet mill or the like (dry-milling method) to produce magnet powder. Thereafter, the resulting magnet powder is put in a mold and pressed to mold to a prescribed shape. Then, the magnet powder molded to the prescribed shape in a solid state is sintered at a prescribed temperature (for example, at 1100° C. for the case of Nd—Fe—B-based magnet) for completion (See, for example, Japanese Laid-Open Patent Application Publication No. 2-266503). In addition, in order to improve magnetic properties of a permanent magnet, magnetic field orientation is generally carried out by applying a magnetic field from outside. In the method for manufacturing a permanent magnet by a conventional powder sintering method, magnet powder is filled into a mold at the time of press molding; and then, a pressure is applied after a magnet field is applied thereto to carry out the magnetic field orientation so as to mold the magnet powder to a shaped body of compressed powder. In other method for manufacturing a permanent magnet such as an extrusion molding method, an injection molding method, and a roll molding method, a magnet has been molded by applying a pressure under the atmosphere in which a magnetic field is applied. By so doing, a shaped body having direction of the axis of easy magnetization (C-axis) of each magnet particle constituting the permanent magnet aligned in a direction of an applied magnetic field can be formed.

As to the method for aligning the axis of easy magnetization of an anisotropic magnet, an axial anisotropy, a radial anisotropy, a polar anisotropy, and the like may be mentioned. Especially, a magnet orientated for a polar anisotropy that is disclosed in Japanese Patent Laid-Open Publication No. 2005-44820 has a higher maximum magnetic flux density as compared with other anisotropic magnets, and can produce a sinusoidal magnet flux distribution. For example, FIG. 13 illustrates ideal magnetic flux distribution curves for a radial anisotropic magnet and a polar anisotropic magnet, respectively. Accordingly, a polar anisotropic magnet, if it is applied, for example, to a magnet for a motor, can not only increase a driving force of the motor, but also suppress a cogging torque; and thus, this is advantageous in accurate control of driving of the motor.

### PRIOR ART DOCUMENTS

### Patent Documents

Patent document 1: Japanese Laid-Open Patent Application Publication No. 02-266503 (page 5)
Patent document 2: Japanese Laid-Open Patent Application Publication No. 2005-44820 (pages 6 to 8)

### DISCLOSURE OF THE INVENTION

### Problems to be Solved by the Invention

However, as depicted in FIG. 13, in the polar anisotropic magnet, the axis of easy magnetization needs to be aligned along a plurality of arc-like shapes. For example, there is a method such as the one in which with shaping to a ring form a magnetic field is applied by a plurality of pulsed electric currents corresponding to number of the poles around a shaped body, as depicted in FIG. 14; however, in this method, there has been a problem that a magnetic field orientation process becomes complicated as compared with a radial anisotropy and the like. In addition, because a circular magnetic field generated around a linear electric current is used, a sufficient magnetic field strength cannot be secured due to restriction of the upper limit of the electric current; and also because the application time of the pulsed magnetic field is short, there has been a risk that sufficient orientation cannot be achieved.

As a result, not only a sufficient orientation cannot be made, but also, due to a filling variation inside a cavity, a variation in the degree of orientation becomes large. In association with this, a variation in the density becomes large, so that the sinusoidal magnetic flux density distribution which is a characteristic of a polar anisotropic ring magnet cannot be obtained; and thus, reduction in the cogging torque, i.e., an object of utilization of the polar anisotropic magnet, could not have been achieved.

In addition, in Patent Document 2 described above, it is proposed that by carrying out the magnetic field orientation using a special in-field shaping die which has a plurality of coils arranged along a cavity surface, the magnetic flux density distribution of a polar anisotropic ring magnet is approximated to an ideal sinusoidal shape as depicted in FIG. 13. However, in conventional magnet manufacturing methods, there has been a limit in approximating to the ideal sinusoidal shape, whereas almost a trapezoid shape distribution has been obtained as depicted in FIG. 15. It should be noted that the magnetic flux portion between the almost trapezoid and the sinusoid as depicted in FIG. 16 does not contribute to a torque, for example, when a polar anisotropic ring magnet is used in an SPM motor. As a consequence, this has been a cause of decrease in a motor efficiency.

Conventionally, because a magnetic field is applied during molding by a powder compaction molding, magnet particles rotationally moves by a pressure applied after the orientation as depicted in FIG. 17, so that the axis of easy magnetization of each particle does not align in the same direction, thereby leading to a problem of a lower degree of orientation. Further, in the powder compaction molding, because of insufficient orientation and unevenness, a variation occurs in the contraction rate by sintering in each lot, thereby leading to a problem that a die design considering the contraction by sintering cannot be made precisely. Therefore, generally, in shaping of the magnet, shaping to a shaped body before sintering needs to be made with considering the contraction by sintering. For example, as depicted in FIG. 18, in the case that a final product having an annular ring shape is produced, if the powder compaction molding is made from the outset by using a cavity having an annular ring shape, due to the contraction by sintering the annular ring shape cannot be obtained after sintering. Therefore, it is needed to design the shape of the cavity with considering the contraction by sintering in advance; however, if the contraction rate by sintering varies in each lot, the design cannot be made precisely. As a result, the shape of product after sintering varies, so that there have been problems including such a problem that an additional process for an outer shape processing is needed after sintering.

The present invention was made to solve the conventional problems as described above, and thus, an object of the present invention is to provide: a permanent magnet wherein even if the permanent magnet is an anisotropic magnet that requires the axis of easy magnetization to be aligned in a complex shape such as a polar anisotropic magnet, not only the magnetic field orientation process can be made simple but also the degree of orientation thereof can be improved; a method for manufacturing a permanent magnet; an SPM motor using a permanent magnet; and a method for manufacturing an SPM motor.

### Means for Solving the Problems

To achieve the above object, the permanent magnet according to the present invention is characterized by that the permanent magnet is manufactured by a method including: milling a magnet raw material into magnet powder; forming a mixture of the magnet powder thus milled with a binder; molding the mixture to a shape of a sheet thereby forming a green sheet; carrying out magnetic field orientation to the green sheet by applying a magnetic field; with laminating and fixing a plurality of the magnetically orientated green sheets under a deformed state thereof, cutting the plurality of the green sheets thus fixed for shaping to a prescribed shape; and sintering the green sheet thus shaped to a prescribed shape by keeping at a sintering temperature.

In addition, the permanent magnet according to the present invention is characterized by that the binder includes a thermoplastic resin, and a residual matter of the green sheet generated by the cutting process of the green sheet for shaping to a prescribed shape is heated thereby reusing the residual matter for the mixture.

In addition, the permanent magnet according to the present invention is characterized by that in the magnetic field orientation process, orientation is made in an in-plane direction of the green sheet, and in the cutting process of the green sheet for shaping to a prescribed shape, the fixing is made such that the plurality of the magnetically orientated green sheets are laminated under a curved state thereof in such a way that a cross section of the green sheet in a thickness direction may be an arc-like shape.

In addition, the permanent magnet according to the present invention is characterized by that the prescribed shape is a fan-like shape, and a plurality of the sintered bodies obtained by sintering in the sintering process or a plurality of the shaped bodies before sintering in the sintering process is arranged in an annular ring shape thereby forming a polar anisotropic ring magnet whose axis of easy magnetization is orientated for a polar anisotropy.

In addition, the SPM motor according to the present invention is characterized by that the permanent magnet according to any one of the above embodiments is disposed on a surface of a rotor.

In addition, the method for manufacturing a permanent magnet according to the present invention is characterized by that the method includes: milling a magnet raw material into magnet powder; forming a mixture of the magnet powder thus milled with a binder; molding the mixture to a shape of a sheet thereby forming a green sheet; carrying out magnetic field orientation to the green sheet by applying a magnetic field; with laminating and fixing a plurality of the magnetically orientated green sheets under a deformed state thereof, cutting the plurality of the green sheets thus fixed for shaping to a prescribed shape; and sintering the green sheet thus shaped to a prescribed shape by keeping at a sintering temperature.

In addition, the method for manufacturing a permanent magnet according to the present invention is characterized by that the binder includes a thermoplastic resin, and a residual matter of the green sheet generated by the cutting process of the green sheet for shaping to a prescribed shape is heated so as to be regenerated for the mixture.

In addition, the method for manufacturing a permanent magnet according to the present invention is characterized by that in the magnetic field orientation process, orientation is made in an in-plane direction of the green sheet, and in the cutting process of the green sheet for shaping to a prescribed shape, the fixing is made such that the plurality of the magnetically orientated green sheets are laminated under a curved state thereof in such a way that a cross section of the green sheet in a thickness direction may be an arc-like shape.

In addition, the method for manufacturing a permanent magnet according to the present invention is characterized by that the prescribed shape is a fan-like shape, and a plurality of the sintered bodies obtained by sintering in the sintering process or a plurality of the shaped bodies before sintering in the sintering process is arranged in an annular ring shape thereby forming a polar anisotropic ring magnet whose axis of easy magnetization is orientated for a polar anisotropy.

In addition, the method for manufacturing an SPM motor according to the present invention is characterized by that the SPM motor is manufactured by disposing on a surface of a rotor the permanent magnet which is manufactured by the method according to any one of the above embodiments.

### Effect of the Invention

According to the permanent magnet of the present invention having the constitutions described above, by appropriately setting a lamination embodiment of the green sheet or a cutting embodiment of the green sheet laminated, the permanent magnet with various shapes having the axis of easy magnetization aligned in an arbitrary direction can be readily realized. For example, even in the anisotropic magnet whose axis of easy magnetization needs to be aligned in a complicate shape such as those of a polar anisotropic magnet, the magnetic field orientation process can be made simple. In addition, because the green sheet molding is used, the magnet particles do not move rotationally after orientation as compared with the case of using powder compaction molding or the like, so that the degree of orientation can be improved as well.

In addition, because the green sheet molding can utilize the number of current turns, a high magnetic field strength can be secured during the time of the magnetic field orientation process; and in addition, because a magnetic field can be applied in a static magnetic field for a long period of time, a high degree of orientation with a low variation thereof can be realized. Further, after orientation, by processing the orientation direction, an orientation with a high orientation and a low variation can be secured.

In addition, realization of a high orientation with a low variation can contribute to reduction in the contraction variation due to sintering. That is, uniformity of the product shape after sintering can be secured. As a result, a burden of an outer shape processing after sintering can be lowered, which contributes, especially in the polar anisotropic ring magnet, to securing of a single sinusoidal variation of the magnet flux density. In addition, a significant improvement of stability in mass production can be expected.

In addition, according to the permanent magnet of the present invention, even in the case that a plurality of the laminated green sheets is subjected to the cutting process to a complicate shape, the residual matter generated by the cutting process can be regenerated as a part of the green sheet, and therefore, decrease in a yield rate can be avoided.

In addition, according to the permanent magnet of the present invention, when the green sheets are laminated under a state curved in an arc-like shape, the axis of easy magnetization can be readily aligned along the arc.

In addition, according to the permanent magnet of the present invention, when a plurality of the sintered bodies or of the shaped bodies is disposed in an annular ring shape, a polar anisotropic ring magnet whose axis of easy magnetization is orientated for a polar anisotropy can be readily formed. In addition, a magnetic flux density distribution with a sinusoidal shape more ideal than ever can be realized.

In addition, according to the SPM motor of the present invention, increase in torque and efficiency with decrease in size and torque ripple more than ever can be realized in the motor.

In addition, according to the method for manufacturing a permanent magnet of the present invention, when a lamination embodiment of the green sheet or a cutting embodiment of the green sheet laminated is set appropriately, the permanent magnet with various shapes having the axis of easy magnetization aligned in an arbitrary direction can be readily manufactured. For example, even in the case that the anisotropic magnet whose axis of easy magnetization needs to be aligned in a complicate shape such as those of a polar anisotropic magnet is produced, the magnetic field orientation process can be made simple. In addition, because the green sheet molding is used, the magnet particles move less rotationally after orientation as compared with the case of using powder compaction molding or the like, so that the degree of orientation can be improved as well.

In addition, because the green sheet molding can utilize the number of current turns, a high magnetic field strength during the time of the magnetic field orientation process can be secured; and in addition, because the magnetic field can be applied for a long period of time in a static magnetic field, the permanent magnet realizing a high degree of orientation with a low variation can be manufactured. Further, when the orientation direction is processed after orientation, a polar orientation with a high orientation and a low variation can be secured.

In addition, realization of a high orientation with a low variation can contribute to reduction in the contraction variation due to sintering. That is, uniformity of the product shape after sintering can be secured. As a result, a burden of an outer shape processing after sintering can be lowered, which contributes, especially in the polar anisotropic ring magnet, to securing of a single sinusoidal variation of the magnet flux density. In addition, a significant improvement of stability in mass production can be expected.

In addition, according to the method for manufacturing a permanent magnet of the present invention, even in the case that a plurality of the laminated green sheets is subjected to the cutting process to a complicate shape, the residual matter generated by the cutting can be regenerated as a part of the green sheet, and therefore, decrease in a yield rate can be prevented from occurring.

In addition, according to the method for manufacturing a permanent magnet of the present invention, by laminating the green sheets under a state curved in an arc-like shape, the permanent magnet whose axis of easy magnetization is aligned along the arc can be readily produced.

In addition, according to the method for manufacturing a permanent magnet of the present invention, when a plurality of the sintered bodies or of the shaped bodies is disposed in an annular ring shape, a polar anisotropic ring magnet whose axis of easy magnetization is orientated for a polar anisotropy can be readily formed. In addition, a magnetic flux density distribution with a sinusoidal shape more ideal than ever can be realized.

In addition, according to the method for manufacturing an SPM motor of the present invention, increase in torque and efficiency with decrease in size and torque ripple more than ever can be realized in the motor.

### BRIEF DESCRIPTION OF THE DRAWINGS

FIG. 1 is an overall view of a permanent magnet according to the present invention.

FIG. 2 is a diagram illustrating a sintered member to constitute the permanent magnet.

FIG. 3 is a diagram illustrating the axis of easy magnetization of the sintered member.

FIG. 4 is an explanatory diagram illustrating the method for manufacturing a permanent magnet according to the present invention.

FIG. 5 is an explanatory diagram specifically illustrating the molding process of the green sheet in the manufacturing process of a permanent magnet according to the present invention.

FIG. 6 is an explanatory diagram specifically illustrating the heating process and the magnetic field orientation process of the green sheet in the manufacturing process of a permanent magnet according to the present invention.

FIG. 7 is a diagram illustrating an example of the magnetic field orientation in a direction perpendicular to a plane of the green sheet.

FIG. 8 is an explanatory diagram specifically illustrating the temperature rising embodiment in the manufacturing process of a permanent magnet according to the present invention.

FIG. 9 is a diagram illustrating an SPM motor wherein a permanent magnet is disposed on a surface of a rotor.

FIG. 10 is a diagram illustrating a modified example of the present invention.

FIG. 11 is a diagram illustrating a modified example of the present invention.

FIG. 12 is a diagram illustrating a modified example of the present invention.

FIG. 13 is an explanatory diagram illustrating a problem of conventional technologies.

FIG. 14 is an explanatory diagram illustrating a problem of conventional technologies.

FIG. 15 is an explanatory diagram illustrating a problem of conventional technologies.

FIG. 16 is an explanatory diagram illustrating a problem of conventional technologies.

FIG. 17 is an explanatory diagram illustrating a problem of conventional technologies.

FIG. 18 is an explanatory diagram illustrating a problem of conventional technologies.

### BEST MODE FOR CARRYING OUT THE INVENTION

Specific embodiments of the permanent magnet and the method for manufacturing a permanent magnet according to the present invention will be described below in detail with reference to the drawings.

[Constitution of Permanent Magnet]

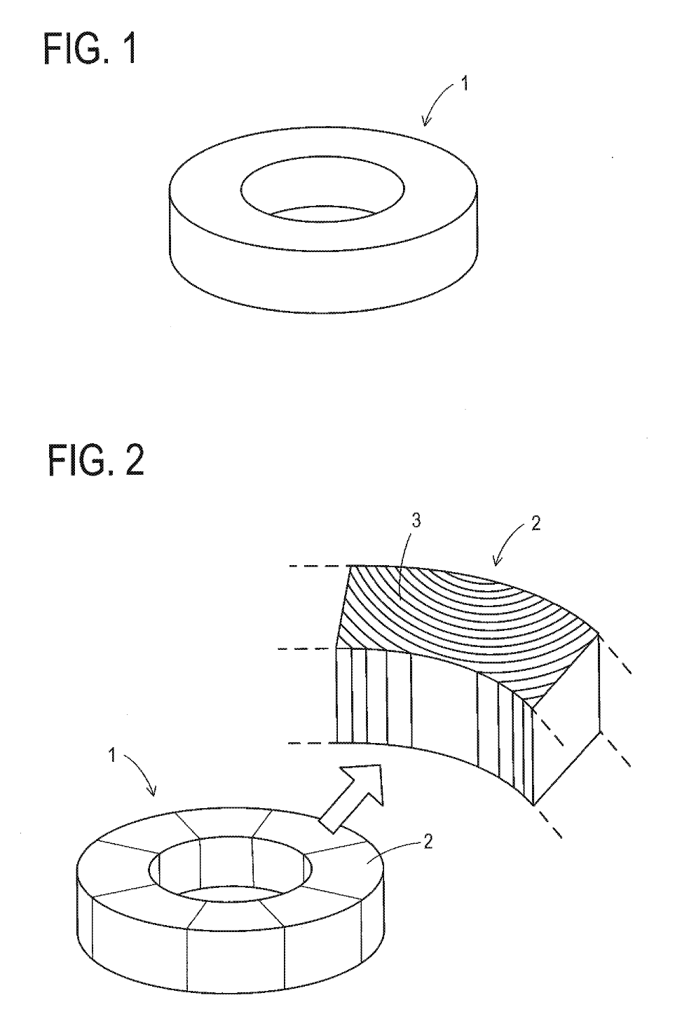

First, a constitution of a permanent magnet 1 according to the present invention will be explained. FIG. 1 is an overall view of the permanent magnet 1 according to the present invention. Meanwhile, as depicted in FIG. 1, the permanent magnet 1 according to the present invention is a polar anisotropic ring magnet having an annular ring shape. Meanwhile, in the below examples, explanation will be made with regard to an example in which the permanent magnet 1 is the polar anisotropic ring magnet; however, a shape and an orientation of the permanent magnet 1 can be arbitrarily changed in accordance with a modification embodiment, a lamination embodiment, or a cutting embodiment of the green sheet, as discussed later.

Further, the permanent magnet 1 according to the present invention is made of an Nd—Fe—B-based magnet. Meanwhile, the contents of respective components are regarded to be 27 to 40% by weight for Nd, 0.8 to 2% by weight for B, and 60 to 70% by weight for Fe (electrolytic iron). Furthermore, the permanent magnet 1 may contain other elements such as Dy, Tb, Co, Cu, Al, Si, Ga, Nb, V, Pr, Mo, Zr, Ta, Ti, W, Ag, Bi, Zn or Mg in small quantities so as to improve the magnetic properties thereof.

In addition, as depicted in FIG. 2, in the permanent magnet 1, after a plurality of sintered members 2 having a fan-like shape (segment type) are fabricated, they are fixed by a resin or the like, which is then followed by magnetization thereof so as to constitute the permanent magnet 1. Meanwhile, the number of the sintered members 2 corresponds to the number of the poles of the permanent magnet 1; and therefore, for example, in the case that the number of the poles of the permanent magnet 1 is regarded to be 8, the permanent magnet 1 is composed of eight sintered members 2, as depicted in FIG. 2.

Further, each sintered member 2 which constitutes the permanent magnet 1 is formed by laminating a plurality of the green sheets 3, as depicted in FIG. 2. Specifically, the sintered member 2 is formed by fixing through lamination of a plurality of the green sheets 3 under a curved state thereof in such a way that a cross section of the green sheet 3 in a thickness direction may be an arc-like shape. The green sheet 3 is a sheet member in a shape of a thin film having the thickness of, for example, in the range of 0.05 to 10 mm (for example 1 mm). And this is formed by molding a mixture of magnet powder with a binder (the mixture is in the form of a slurry or a compound; these will be discussed later) to a shape of a sheet.

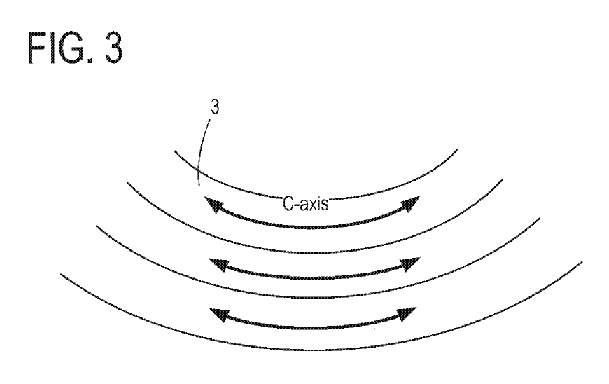

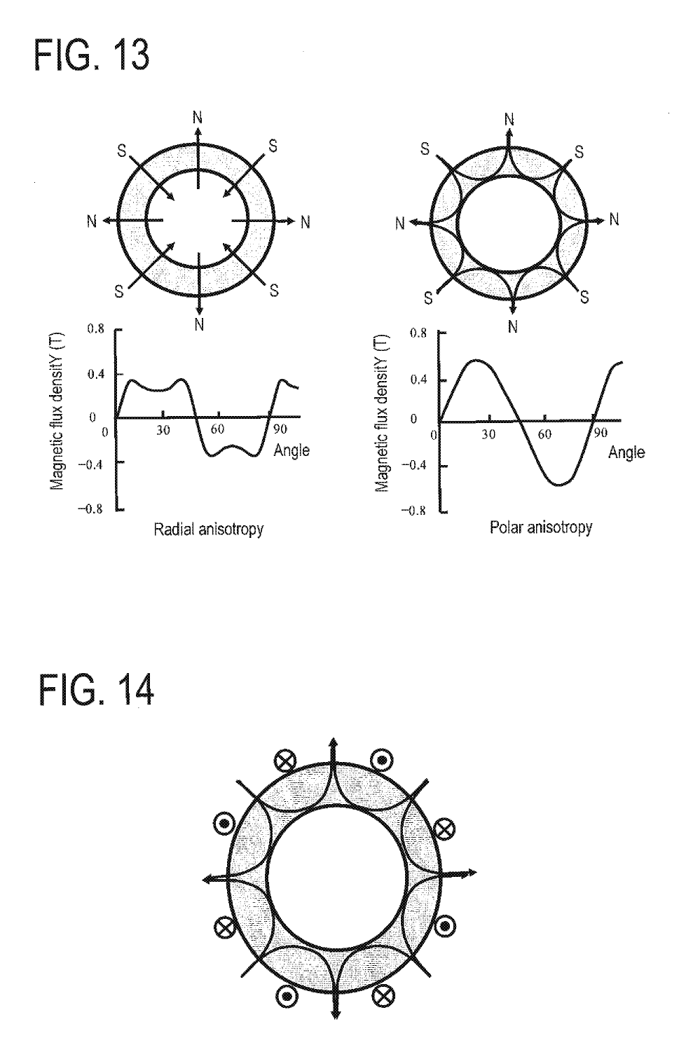

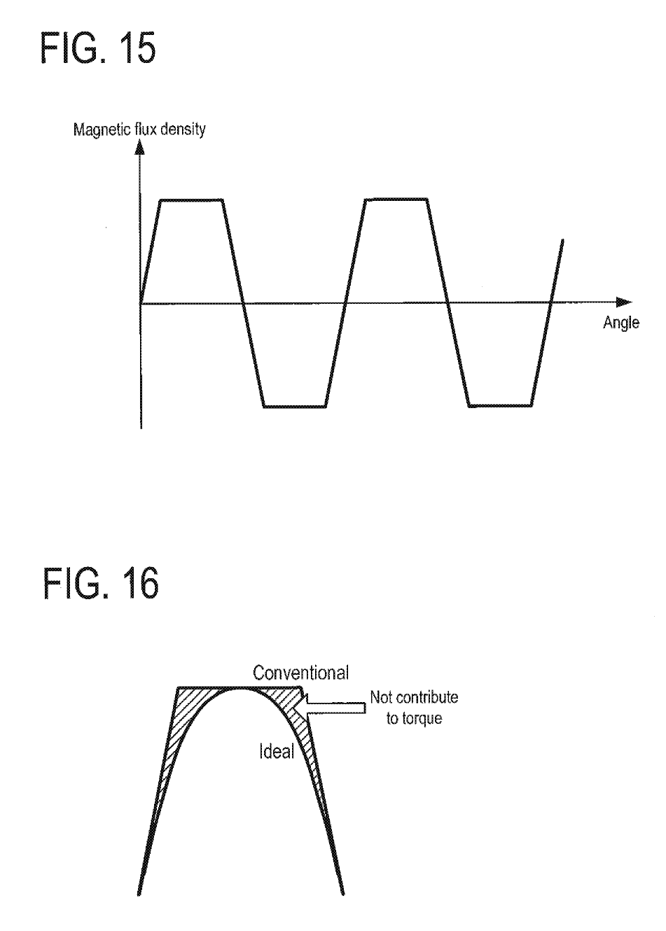

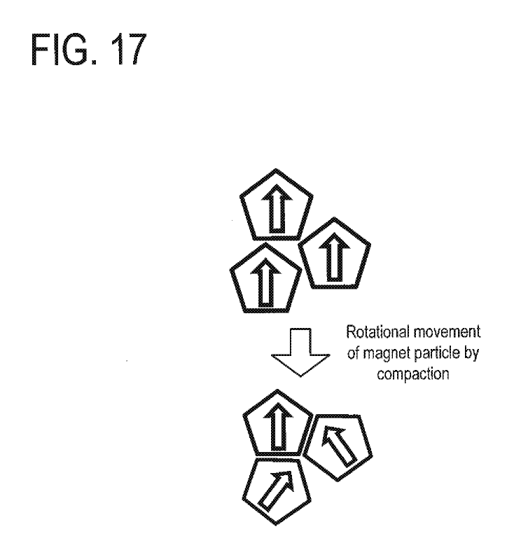

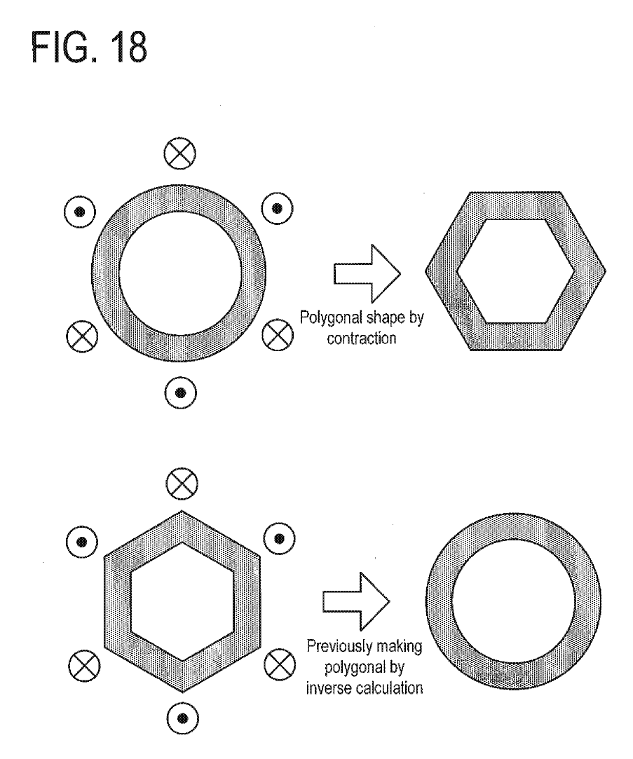

Also, in the green sheet 3, the orientation is made in an in-plane direction in the magnetic field orientation process, as discussed later. Accordingly, as depicted in FIG. 3, the axis of easy magnetization (C-axis) of the sintered member 2 is formed in an arc-like shape along the in-plane direction of the green sheet 3, resulting in the constitution that the orientation of the permanent magnet 1 formed by fabricating the sintered members 2 with each other has a polar anisotropy, as depicted in FIG. 13.

Also, in the present invention, especially in the case that the permanent magnet 1 is manufactured by the green sheet molding, illustrative example of the binder to be mixed with the magnet powder includes a resin, a long-chain hydrocarbon, a fatty acid ester, and a mixture of them.

Further, in the case that a resin is used for the binder, the resin to be used is preferably a polymer having no oxygen atom in its structure and being capable of depolymerization. In addition, in order to reuse a residual matter of the green sheet 3 which is generated at the time of cutting the laminated green sheet 3 to be mentioned later is cut to a prescribed shape (for example, a fan-like shape), and also in order to carry out the magnetic field orientation of the green sheet 3 in a softened state by heating, a thermoplastic resin is used. Specifically, the resin belonging to this is a polymer or a copolymer of one or more kinds of monomers selected from monomers represented by the following general formula (1), provided that R1 and R2 each in the formula represent a hydrogen atom, a lower alkyl group, a phenyl group, or a vinyl group.

### [Chem. 1]

Illustrative example of the polymer satisfying the above condition include polyisobutylene (PIB; polymer of isobutylene), polyisoprene (isoprene rubber or IR; polymer of isoprene), polybutadiene (butadiene rubber or BR; polymer of butadiene), polystyrene (polymer of styrene), styrene-isoprene block copolymer (SIS; copolymer of styrene and isoprene), butyl rubber (IIR; copolymer of isobutylene and isoprene), styrene-butadiene block copolymer (SBS; copolymer of styrene and butadiene), poly(2-methyl-1-pentene) (polymer of 2-methyl-1-pentene), poly(2-methyl-1-butene) (polymer of 2-methyl-1-butene), and poly(α-methylstyrene) (polymer of α-methylstyrene). Meanwhile, a low molecular weight polyisobutylene is preferably added to the poly(α-methylstyrene) to render flexibility thereto. Also, an embodiment may also be allowed that the resin to be used for the binder contains small quantities of a polymer or a copolymer of an oxygen-containing monomer (such as poly(butyl methacrylate) and poly(methyl methacrylate)). Further, a monomer not satisfying the above general formula (1) may be partially copolymerized thereto. Even in such a case, the purpose of the present invention can be realized.

Meanwhile, in order to suitably carry out the magnetic field orientation, the binder is preferably made of a thermoplastic resin that softens at 250° C. or lower, or more specifically, a thermoplastic resin whose glass transition point or melting point is 250° C. or lower.

On the other hand, in the case that a long-chain hydrocarbon is used for the binder, a long-chain saturated hydrocarbon (long-chain alkane), which is a solid at room temperature and a liquid at a temperature higher than room temperature, is preferably used. Specifically, a long-chain saturated hydrocarbon having 18 or more carbon atoms is preferably used. At the time when the green sheet is subjected to the magnetic field orientation as mentioned later, the magnetic field orientation is carried out under a state where the green sheet is softened by heating the green sheet at a temperature equal to or higher than the melting point of the long-chain hydrocarbon.

Likewise, in the case that a fatty acid ester is used for the binder, methyl stearate, methyl docosanoate, or the like, these being a solid at room temperature and a liquid at a temperature higher than room temperature, is preferably used. At the time when the green sheet is subjected to the magnetic field orientation as mentioned later, the magnetic field orientation is carried out under a state where the green sheet is softened by heating the green sheet at a temperature equal to or higher than the melting point of the fatty acid ester.

By using a binder that satisfies the above condition as the binder to be mixed with the magnet powder at the time of forming the green sheet, the carbon content and oxygen content in the magnet can be reduced. Specifically, the carbon content remaining in the magnet after sintering is made 2000 ppm or less, while more preferably 1000 ppm or less. Also, the oxygen content remaining in the magnet after sintering is made 5000 ppm or less, while more preferably 2000 ppm or less.

Further, the amount of the binder to be added may be an appropriate amount to fill the spaces among magnet particles so as to improve the thickness accuracy of the sheet at the time when the slurry or the compound molten by heating is molded to the sheet shape. For example, the ratio of the binder to the total amount of the magnet powder and the binder is preferably in the range of 1 to 40% by weight, more preferably in the range of 2 to 30% by weight, while still more preferably in the range of 3 to 20% by weight.

[Method for Manufacturing Permanent Magnet]

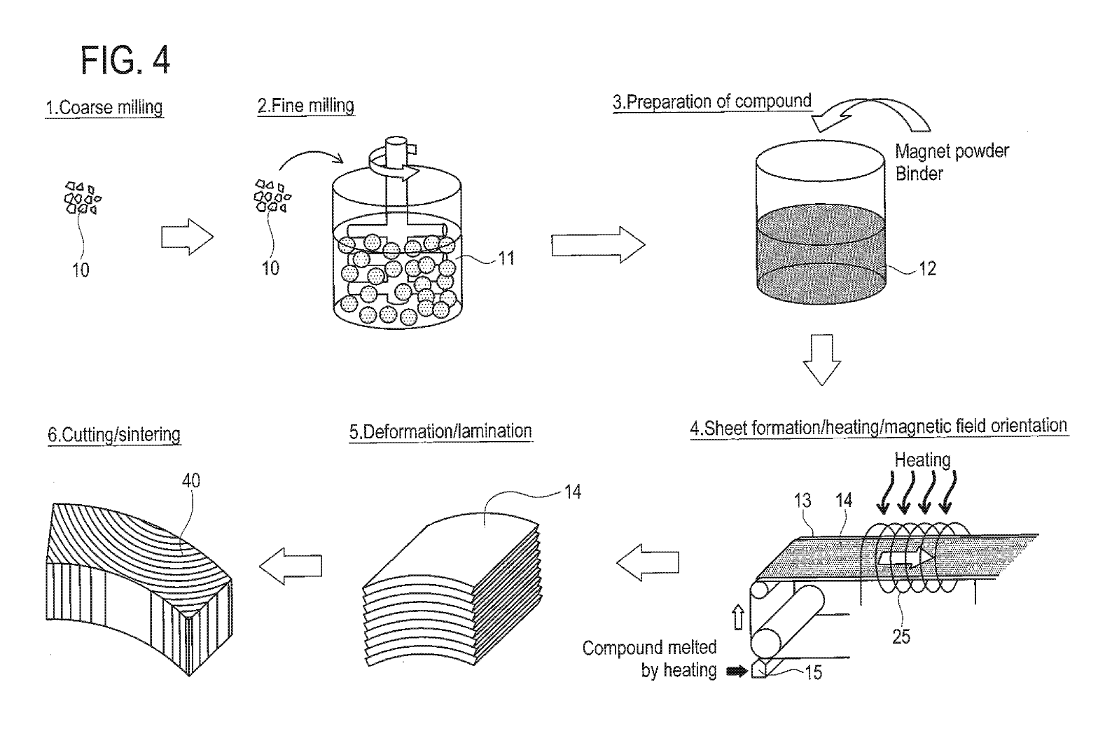

Next, the method for manufacturing the permanent magnet 1 according to the present invention will be described below with reference to FIG. 4. FIG. 4 is an explanatory view illustrating the manufacturing process of the permanent magnet 1 according to the present invention.

First, an ingot including Nd—Fe—B with a prescribed fraction (for example, Nd: 32.7% by weight, Fe (electrolytic iron): 65.96% by weight, and B: 1.34% by weight) is prepared. Thereafter, the ingot is coarsely milled by using a stamp mill, a crusher, or the like to a size of about 200 μm. Alternatively, the ingot is melted, formed into flakes by using a strip-casting method, and then coarsely milled by using a hydrogen pulverization method. By so doing, coarsely milled magnet powder 10 can be obtained.

Next, the coarsely milled magnet powder 10 is finely milled by a wet method using a bead mill 11, or a dry method using a jet mill, or the like. For example, in fine milling using a wet method with the bead mill 11, the coarsely milled magnet powder 10 is finely milled to a particle size of within a prescribed range (for example, in the range of 0.1 to 5.0 μm) in a solvent whereby dispersing the magnet powder into the solvent. Thereafter, the magnet powder contained in the solvent after the wet milling is dried by such a method as vacuum drying to obtain the dried magnet powder. The solvent to be used in the milling is not particularly restricted, wherein illustrative example of the solvent that can be used includes alcohols such as isopropyl alcohol, ethanol, and methanol; esters such as ethyl acetate; lower hydrocarbons such as pentane and hexane; aromatics such as benzene, toluene, and xylene; ketones; and a mixture thereof. Meanwhile, it is preferable to use a solvent not containing an oxygen atom therein.

On the other hand, in fine milling using the dry method with a jet mill, the coarsely milled magnet powder is finely milled with the jet mill in: (a) an atmosphere including an inert gas such as a nitrogen gas, an argon (Ar) gas, a helium (He) gas, or the like, wherein an oxygen content therein is substantially 0%; or (b) an atmosphere including an inert gas such as a nitrogen gas, an Ar gas, a He gas, or the like, wherein an oxygen content therein is in the range of 0.0001 to 0.5%, to form fine powder whose average particle diameter is within a prescribed range (for example, in the range of 0.7 to 5.0 μm). Meanwhile, the term “an oxygen content therein is substantially 0%” is not limited to a case where the oxygen content is completely 0%, but may include a case where oxygen is contained in such an amount as to allow formation of an oxide film only faintly on the surface of the fine powder.

Next, the magnet powder finely milled by the bead mill 11 or the like is molded to a desired form. Meanwhile, molding of the magnet powder is carried out by molding the mixture of the magnet powder with the binder. In examples illustrated below, the mixture is once molded to a shape other than a shape of a final product, which is then followed by the magnetic field orientation, and thereafter, the shape of the final product may be obtained by processing with punching, cutting, deforming, or the like. Especially in examples illustrated below, the mixture is once molded to a shape of a sheet (hereinafter, this is referred to as a green sheet), and then this sheet is processed to the shape of the final product. In the case that the mixture is molded especially to the shape of a sheet, there may be molding methods for it such as: a hot-melt coating method in which a compound, i.e., a mixture of the magnet powder with the binder, is prepared and then followed by molding this compound to a shape of a sheet after it is heated; a slurry coating method in which a slurry containing the magnet powder, the binder, and an organic solvent is applied onto a substrate thereby molding to a shape of a sheet; and the like.

Hereinafter, the green sheet molding using the hot-melt coating method will be specifically explained.

First, a binder is mixed with the magnet powder which is finely milled by the bead mill 11 or the like thereby obtaining a powdery mixture (compound) 12 including the magnet powder and the binder. Here, as mentioned before, a resin, a long-chain hydrocarbon, a fatty acid ester, a mixture thereof, or the like is used as the binder. For example, in the case that a resin is used, it is preferable to use a thermoplastic resin including a polymer which is capable of depolymerization and is a polymer of monomers not having an oxygen atom in its structure; and in the case that a long-chain hydrocarbon is used, it is preferable to use a long-chain saturated hydrocarbon (long-chain alkane) which is a solid at room temperature and a liquid at a temperature higher than room temperature. In the case that a fatty acid ester is used, methyl stearate, methyl docosanoate, or the like is preferably used. Here, the amount of the binder to be added is preferably such that the ratio of the binder to the total amount of the magnet powder and the binder in the compound 12 after the addition as mentioned before may be in the range of 1 to 40% by weight, more preferably in the range of 2 to 30% by weight, while still more preferably in the range of 3 to 20% by weight.

In addition, in order to improve the degree of orientation in the later process of the magnetic field orientation, an additive to facilitate the orientation may be added to the compound 12. An illustrative example of the additive to facilitate the orientation is a hydrocarbon-based additive, wherein the use of a polar additive (specifically the acid dissociation constant pKa of less than 41) is especially preferable. Addition amount of the additive is dependent on the particle diameter of the magnet powder, wherein more amounts thereof are needed with smaller particle diameter of the magnet powder. Specifically, the addition amount thereof relative to the magnet powder is preferably in the range of 0.1 to 10 parts by mass, while more preferably in the range of 1 to 8 parts by mass. The additive that is added to the magnet powder attaches to a surface of the magnet particle, whereby playing a role to facilitate a rotation movement of the magnet particle in the later-mentioned magnetic field orientation process. As a result, the orientation takes place easily at the time when the magnetic field is applied, so that the axis of easy magnetization of each magnet particle can be aligned in the same direction (namely, a higher degree of orientation can be obtained). Especially in the case that the binder is added to the magnet powder, because the binder is present on the particle surface, a friction force during the orientation becomes larger thereby leading to decrease in orientation of the particles; and therefore, the effect of adding the additive is enhanced furthermore.

Meanwhile, addition of the binder is carried out under an atmosphere including an inert gas such as a nitrogen gas, an Ar gas, and a He gas. Meanwhile, mixing of the magnet powder with the binder is carried out, for example, by adding the magnet powder and the binder each into a stirring equipment whereby stirring them with a stirrer. Alternatively, in order to facilitate kneading, the stirring may be carried out with heating. Further, it is preferable to carry out the mixing of the magnet powder with the binder under an atmosphere including an inert gas such as a nitrogen gas, an Ar gas, and a He gas. Especially in the case that the magnet powder is obtained by milling with a wet method, an embodiment may be allowed that without taking out the magnet powder from a solvent used in the milling, the binder is added to the solvent, which is followed by kneading the resulting mixture and then evaporating the solvent from it, thereby the compound 12 to be mentioned later is obtained.

Next, a green sheet is prepared by molding the compound 12 to a shape of a sheet. Especially in the hot-melt coating method, the compound 12 is melted by heating the compound 12 to make it a fluid state, which is then followed by coating onto a supporting substrate 13 such as a separator. Thereafter, it is allowed to be cooled for solidification to form the green sheet 14 in the shape of a long sheet on the supporting substrate 13. Meanwhile, although the temperature of heating the compound 12 for melting is different dependent on the kind and amount of the binder to be used, the temperature is made in the range of 50 to 300° C. However, the temperature needs to be made higher than a melting point of the binder to be used. Meanwhile, in the case that the slurry coating method is used, the magnet powder and the binder (in addition, the additive to facilitate the orientation may also be included therein) are dispersed into a large amount of an organic solvent, and then the resulting slurry is coated onto the supporting substrate 13 such as a separator. Thereafter, the organic solvent is evaporated by drying, resulting in formation of the green sheet 14 in the shape of a long sheet on the supporting substrate 13.

Here, as to the coating method of the molten compound 12, a method having excellent controllability of the layer thickness, such as a slot-die method and a calendar roll method, is preferably used. Especially in order to realize high thickness accuracy, a die method or a comma coating method, both having excellent controllability of the layer thickness (namely, the method with which a layer having high thickness accuracy can be coated on the substrate surface), is preferably used. For example, in the slot-die method, the compound 12 melted to a fluid state by heating is extruded by a gear pump to put into the die thereby performing the coating. In the calendar roll method, a prescribed amount of the compound 12 is charged into a gap between two heated rolls, and the compound 12 melted by the heat of the rolls is coated onto the supporting substrate 13 with rotating the rolls. As to the supporting substrate 13, for example, a silicone-treated polyester film is used. Further, it is preferable to carry out a defoaming treatment thoroughly by using a defoaming agent, or by a heat and vacuum defoaming method, or the like, so that air bubbles may not remain in a developing layer. Further, instead of coating onto the supporting substrate 13, an embodiment may also be allowed that while being molded to a shape of a sheet by using an extrusion molding or an injection molding, the compound 12 melted is extruded onto the supporting substrate 13 thereby molding it to the green sheet 14 on the supporting substrate 13.

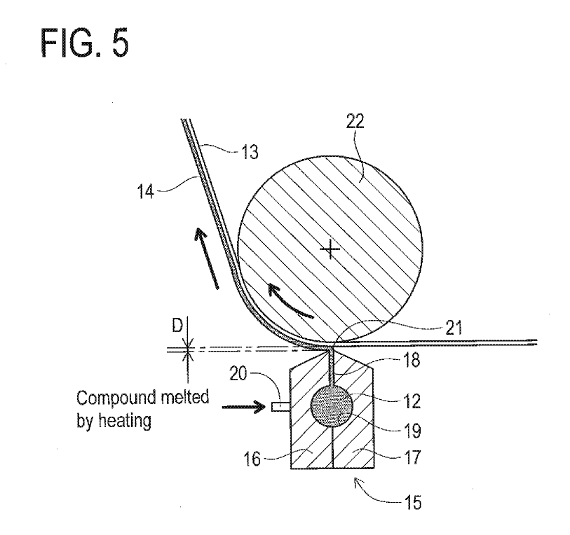

Hereunder will be given a more detailed description of the formation process of the green sheet 14 by using a slot-die method with referring to FIG. 5. FIG. 5 is an explanatory diagram illustrating the formation process of the green sheet 14 by using the slot-die method.

As depicted in FIG. 5, a slot die 15 used for the slot-die method is formed by putting blocks 16 and 17 together thereby forming a slit 18 and a cavity (liquid pool) 19 by a space between the blocks 16 and 17. The cavity 19 communicates with an inlet port 20 formed in the block 17. Further, the inlet port 20 is connected to a coating fluid feed system configured with the gear pump and so forth (not illustrated), and the cavity 19 receives a metered feed of the compound 12 in a fluid state through the inlet port 20 by means of a metering pump or the like. Further, the compound 12 in a fluid state fed to the cavity 19 is delivered to the slit 18, and discharged with a constant amount per unit time and with a predetermined coating width from an outlet port 21 of the slit 18 with a uniform pressure in transverse direction. On the other hand, the supporting substrate 13 is continuously conveyed with the rotation of a coating roll 22 at a predetermined speed. As a result, the mixture 12 in a fluid state discharged is laid down onto the supporting substrate 13 with a prescribed thickness. Thereafter, the compound 12 is allowed to stand for cooling and solidifying thereby forming the green sheet 14 in the shape of a long sheet on the supporting substrate 13.

Further, in the formation process of the green sheet 14 by the slot-die method, it is preferable to measure the actual sheet thickness of the green sheet 14 after coating, thereby performing, on the basis of the measured thickness, the feedback control of a gap D between the slot die 15 and the supporting substrate 13. Further, it is preferable to minimize the variation in the feed rate of the compound 12 in a fluid state supplied to the slot die 15 (for example, to suppress the variation within plus or minus 0.1%), and in addition, to also minimize the variation in the coating speed (for example, to suppress the variation within plus or minus 0.1%). As a result, thickness accuracy of the green sheet 14 can further be improved. Meanwhile, the thickness accuracy of the green sheet 14 thereby formed is within a margin of error of plus or minus 10% relative to a designed value (for example, 1 mm), preferably within plus or minus 3%, while more preferably within plus or minus 1%. Alternatively, in the calendar roll method, the film thickness of the compound 12 transferred onto the supporting substrate 13 can be controlled by controlling calendaring conditions according to an actual measurement value.

Meanwhile, a predetermined thickness of the green sheet 14 is preferably in the range of 0.05 to 20 mm. If the thickness is predetermined to be thinner than 0.05 mm, it needs to laminate many layers, which lowers the productivity.

Next, the magnetic field orientation is carried out to the green sheet 14 on the supporting substrate 13 formed by the above-mentioned hot-melt coating method. Specifically, to begin with, the green sheet 14 conveyed together with the supporting substrate 13 is softened by heating. Specifically, the softening is carried out until the green sheet 14 reaches the viscosity of in the range of 1 to 1500 Pa·s, while more preferably in the range of 1 to 500 Pa·s. By so doing, the magnetic field orientation can be made properly.

Meanwhile, the appropriate temperature and duration for heating the green sheet 14 differ depending on the type or amount of the binder, but can be tentatively set, for example, at 100 to 250° C., and 0.1 to 60 minutes, respectively. However, for the purpose of softening the green sheet 14, the temperature needs to be equal to or higher than the glass transition point or melting point of the binder to be used. Further, the heating method for heating the green sheet 14 may be such a method as heating by a hot plate, or heating using a heating medium (silicone oil) as a heat source. Next, the magnetic field orientation is carried out by applying a magnetic field in an in-plane and machine direction of the green sheet 14 having been softened by heating. The intensity of the applied magnetic field is in the range of 5000 to 150000 [Oe], while preferably in the range of 10000 to 120000 [Oe]. As a result, the C-axis (axis of easy magnetization) of each magnet crystal contained in the green sheet 14 is aligned in one direction. Meanwhile, the application direction of the magnetic field may also be an in-plane and transverse direction of the green sheet 14. Alternatively, an embodiment that the magnetic field is simultaneously applied to plural pieces of the green sheet 14 may also be allowed.

Further, when the magnetic field is applied to the green sheet 14, an embodiment that the magnetic field is applied simultaneously with the heating may be allowed; or an embodiment that the magnetic field is applied after the heating and before the green sheet 14 solidifies may also be allowed. Alternatively, an embodiment that the magnetic field is applied before the green sheet 14 formed by the hot-melt coating solidifies may also be allowed. In such a case, the heating process is not needed.

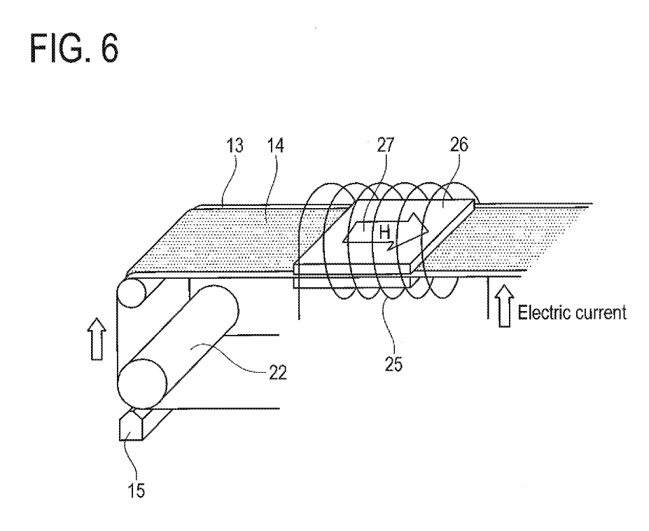

Next, the heating process and the magnetic field orientation process of the green sheet 14 will be explained in more detail with referring to FIG. 6. FIG. 6 is a schematic diagram illustrating the heating process and the magnetic field orientation process of the green sheet 14. Meanwhile, with referring to FIG. 6, an explanation will be made as to the example wherein the heating process and the magnetic field orientation process are carried out simultaneously.

As depicted in FIG. 6, the heating and the magnetic field orientation to the green sheet 14 having been coated by the above described slot-die method are carried out to the green sheet 14 in the shape of a long sheet which is in the continuously conveyed state by a roll. That is, apparatuses for the heating and the magnetic field orientation are arranged in the downstream side of a coating apparatus (such as a slot-die apparatus) so as to perform the heating and the magnetic field orientation subsequent to the coating process.

Specifically, a solenoid 25 is arranged in the downstream side of the slot die 15 and the coating roll 22 so that the green sheet 14 and the supporting substrate 13 being conveyed together may pass through the solenoid 25. Further, inside the solenoid 25, hot plates 26 are arranged as a pair on upper and lower sides of the green sheet 14. While heating the green sheet 14 by the hot plates 26 arranged as a pair on the upper and lower sides, electric current is applied to the solenoid 25 thereby generating a magnetic field in an in-plane direction (i.e., direction parallel to a sheet surface of the green sheet 14) as well as a machine direction of the green sheet 14 in the shape of a long sheet. Thus, the green sheet 14 continuously conveyed is softened by heating, and at the same time the magnetic field is applied to the green sheet 14 thus softened in the in-plane and machine direction of the green sheet 14 (direction of the arrow 27 in FIG. 5), so that the magnetic field orientation can be made on the green sheet 14 appropriately and uniformly. Especially, application of the magnetic field in the in-plane direction thereof can prevent surface of the green sheet 14 from bristling up.

Further, the green sheet 14 after the magnetic field orientation process is preferably cooled and solidified under the state of being conveyed, for the sake of higher efficiency in the manufacturing process.

Meanwhile, in the case that the magnetic field orientation is made in an in-plane and transverse direction of the green sheet 14, an embodiment is made such that the solenoid 25 may be replaced with a pair of magnetic coils arranged on the right and left sides of the green sheet 14 under the state of being conveyed. Through energizing both magnetic coils, a magnetic field can be generated in an in-plane and transverse direction of the green sheet 14 in the shape of a long sheet.

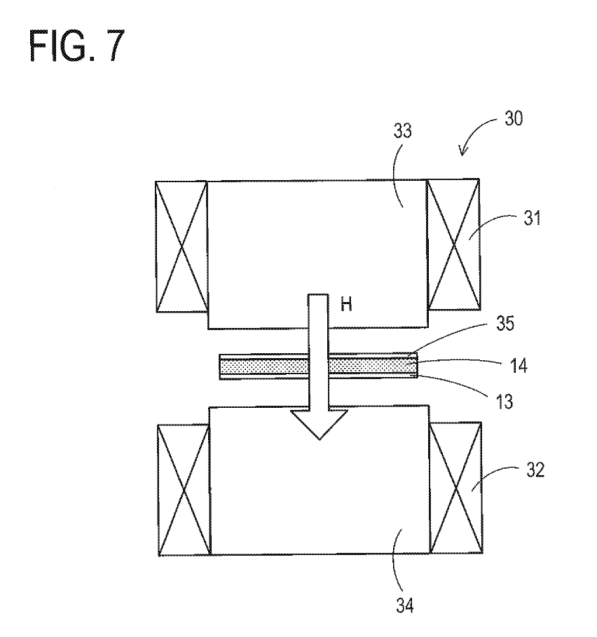

Further, the magnetic field orientation may also be made in a direction perpendicular to a plane of the green sheet 14. In the case that the magnetic field orientation is made in the direction perpendicular to a plane of the green sheet 14, for example, a magnetic field application apparatus using pole pieces or the like may be used. Specifically, as depicted in FIG. 7, a magnetic field application apparatus 30 using pole pieces or the like has two coil portions 31 and 32 in the ring-like shape which are arranged in parallel with each other and coaxially aligned, as well as two pole pieces 33 and 34 almost in the column-like shape which are arranged inside ring holes of the coil portions 31 and 32, respectively, wherein the magnetic field application apparatus 30 is arranged so as to have a prescribed clearance to the green sheet 14 under the state of being conveyed. The coil portions 31 and 32 are energized to generate a magnetic field in the direction perpendicular to the plane of the green sheet 14 to carry out the magnetic field orientation of the green sheet 14. Meanwhile, in the case that the magnetic field orientation is made in the direction perpendicular to the plane of the green sheet 14, it is preferable to laminate a film 35 on the surface opposite to the supporting substrate 13 that is laminated to the green sheet 14, as depicted in FIG. 7. By so doing, the surface of the green sheet 14 can be prevented from bristling up.

Further, instead of the heating method that uses the hot plates 26 as mentioned above, a heating method that uses a heating medium (silicone oil) as a heat source may be used as well.

Here, instead of employing the hot-melt molding method, in the case that the green sheet 14 is formed by a conventional slot-die method or a doctor blade method using a liquid material having high fluidity such as slurry, when the green sheet 14 is conveyed into the place where there is a magnetic field gradient, the magnet powder contained in the green sheet 14 is attracted to a stronger magnetic field, thereby leading to a risk of liquid localization of the slurry destined to form the green sheet 14, i.e., a risk of imbalance in the thickness of the green sheet 14. In contrast, in the case that the hot-melt molding method is employed for molding of the compound 12 to the green sheet 14 as in the present invention, the viscosity of the compound 12 reaches several tens to hundreds of thousand Pa·s at a temperature near a room temperature, so that there is no localization of the magnet powder during the time when the green sheet 14 is passing through the magnetic field gradient. Further, the viscosity of the binder therein becomes lower as the green sheet 14 is conveyed into a homogenous magnetic field and heated therein, and therefore, the uniform C-axis orientation becomes attainable merely by the rotary torque in the homogeneous magnetic field.

Further, in the case that the green sheet 14 is formed by using a liquid material having high fluidity such as an organic solvent-containing slurry by a conventional slot-die method or a doctor blade method, instead of employing the hot-melt molding method, if a sheet having the thickness of more than 1 mm is going to be formed, problematic bubbles may be formed during a drying process by evaporation of the organic solvent contained in the slurry or the like. Further, if the duration of the drying process is extended in order to suppress bubbles, the magnet powder is caused to be separated, resulting in an imbalanced density distribution of the magnet powder in the gravity direction, which in turn may cause warpage of the permanent magnet after sintering. Accordingly, in the formation from the slurry, the maximum thickness is virtually restricted; and therefore, the green sheet 14 needs to be thin with the thickness of 1 mm or less and to be laminated thereafter. However, in such a case, the binder cannot be sufficiently intermingled, which causes interlayer-delamination in the subsequent binder removal process (calcination process), leading to degradation in the orientation in the C-axis (axis of easy magnetization), namely, causing to decrease in the residual magnetic flux density (Br). In contrast, in the case that the compound 12 is molded to the green sheet 14 by using the hot-melt molding method as in the present invention, because the compound 12 does not contain an organic solvent, there is no risk of such bubbles as mentioned above, even if a sheet having the thickness of more than 1 mm is prepared. Further, because the binder is well intermingled, there is no risk of the interlayer-delamination in the binder removal process.

Further, in the case that plural pieces of the green sheet 14 are simultaneously exposed to the magnetic field, for example, an embodiment may be allowed that the plural pieces of the green sheet 14 laminated in multiple layers (for example, six layers) are continuously conveyed whereby the laminated multiple layers of the green sheet 14 are made to pass through inside the solenoid 25. By so doing, the productivity can be improved.

Next, the green sheet 14 having been subjected to the magnetic field orientation process is cut to a certain size so as to be easily processed, and then, the green sheet 14 is deformed in accordance with the direction of the axis of easy magnetization required for a final product. Further, a plurality of the green sheets 14 having been deformed into the same shape are laminated and fixed with each other by a resin or the like. For example, when the polar anisotropic ring magnet illustrated in FIG. 1 and FIG. 2 is produced, the plurality of the green sheets 14 having been magnetically orientated in the in-plane direction are laminated under a curved state thereof in such a way that a cross section of the green sheet 14 in a thickness direction may be an arc-like shape. Meanwhile, the lamination may be made after deforming the green sheet 14, or the deformation may be made after the lamination thereof. In addition, when the green sheet 14 is deformed, the green sheet 14 may be heated so that the deformation thereof may be made more easily. The direction of the deformation may be the thickness direction of the green sheet 14 as depicted in FIG. 4, or the in-plane direction thereof.

Next, by cutting the laminate of the green sheet 14, the shaped body 40 is formed. Meanwhile, the shape of the shaped body 40 differs depending on the shape of a final product; and for example, when the polar anisotropic ring magnet that is illustrated in FIG. 1 and FIG. 2 is produced, a fan-like shape as depicted in FIG. 4 is formed. Meanwhile, in the case that the magnetic field orientation is made in the in-plane direction of the green sheet 14, the in-plane direction of the laminated green sheet 14 corresponds to the direction of the axis of easy magnetization; and thus, the cutting thereof needs to be made with considering the axis of easy magnetization required in the final product. For example, when the polar anisotropic ring magnet is produced, the cutting is made such that the green sheet 14 may be laminated in the arc-like shape whose center is in the periphery side of the fan-like shape.

In addition, a residual matter of the green sheet 14 which is generated in the cutting process of the laminate of the green sheet 14 can be reused as the molten compound 12 by heating the residual matter at the temperature equal to or higher than a melting point of the binder. As a result, the residual matter which is reused is regenerated as a part of the green sheet 14. Accordingly, even in the case that the cutting process is made to a complicate shape, the yield rate does not decrease.

Next, the shaped body 40 thus shaped is kept at a decomposition temperature of the binder (if an additive to facilitate the orientation is added, this temperature also needs to satisfy the condition that it is equal to or higher than a decomposition temperature of the additive) for several hours to several tens of hours (for example, five hours) in a non-oxidizing atmosphere (especially in the present invention, a hydrogen atmosphere or a mixed gas atmosphere of hydrogen and an inert gas) at a normal atmospheric pressure, or a pressure higher or lower than the normal atmospheric pressure (for example, 1.0 Pa or 1.0 MPa), thereby the calcination process is carried out. In the case that the calcination is carried out in a hydrogen atmosphere, the hydrogen feed rate during the calcination is made, for example, 5 L/minute. By carrying out the calcination, organic compounds including the binder can be decomposed by a depolymerization reaction into monomers, which can be scatteringly removed therefrom. That is, so-called decarbonization is carried out with which carbon content in the shaped body 40 can be reduced. Furthermore, the calcination is carried out under such a condition that carbon content in the shaped body 40 may become 2000 ppm or less, while more preferably 1000 ppm or less. By so doing, it becomes possible to densely sinter the entirety of the permanent magnet 1 in the subsequent sintering process, so that there is no decrease in the residual magnetic flux density or in the coercive force. Furthermore, in the case that the calcination is carried out under the pressure condition of higher than an atmospheric pressure, the pressure is preferably 15 MPa or lower. Meanwhile, the pressure condition of higher than an atmospheric pressure, more specifically the pressure of 0.2 Mpa or higher, especially contributes to reduction in the carbon content.

Meanwhile, the decomposition temperature of the binder is determined on the basis of the analysis results of the binder decomposition products and decomposition residues. Specifically, the temperature is selected from such a range that when the binder decomposition products are trapped, no decomposition products except monomers are formed and no products due to the side reaction of residual binder components are detected in the analysis of the residues. The temperature differs depending on the type of binder, but may be set in the range of 200 to 900° C., while more preferably in the range of 400 to 600° C. (for example, 450° C.).

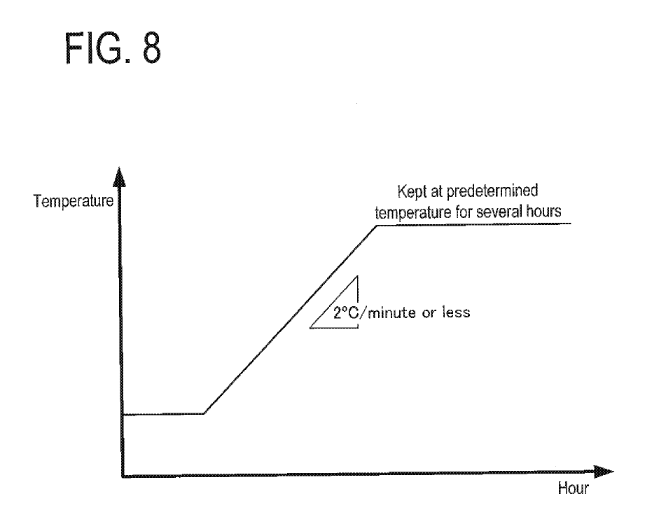

In addition, the calcination is carried out preferably at a slower temperature rising rate as compared with a general magnet sintering process. Specifically, the temperature rising rate is made 2° C./minute or less (for example, 1.5° C./minute). Therefore, in the case that the calcination is carried out, the calcination is carried out in the way as depicted in FIG. 8, that is, the temperature is raised at the prescribed temperature rising rate of 2° C./minute or less, and after the temperature reaches a predetermined set temperature (decomposition temperature of the binder), the shaped body is kept at the set temperature for several hours to tens of hours. When the temperature rising rate in the calcination process is made slow as mentioned above, the carbons in the shaped body 40 are not removed too rapidly but removed gradually; and thus, the density of the permanent magnet after sintering can be made higher (namely, the spaces in the permanent magnet can be made less). And, when the temperature rising rate of 2° C./minute or less is selected, the density of 95% or more is attainable in the permanent magnet after sintering, so that high magnet properties can be expected.

Further thereafter, dehydrogenation may be carried out by keeping in a vacuum atmosphere the shaped body 40 calcined in the calcination process. In the dehydrogenation process, NdH₃ (having high activity, formed in the calcination process) in the shaped body 40 is gradually changed from NdH₃ (having high activity) to NdH₂ (having low activity), so that the activity of the shaped body 40, which is activated by the calcination process, decreases. Accordingly, even if the shaped body 40 calcined by the calcination process is later moved into an atmosphere, Nd therein is prevented from combining with oxygen, so that there is no decrease in the residual magnetic flux density or in the coercive force. In addition, an effect may be expected that the crystal structure of the magnet is put back to the structure of Nd₂Fe₁₄B from those of NdH₂ and the like.

Next, the sintering process in which the shaped body 40 having been calcined in the calcination process is subjected to sintering is carried out. Meanwhile, as to the sintering method of the shaped body 40, the usable method thereof includes a pressure sintering in which the shaped body 40 is sintered under a pressurized state, in addition to a generally used vacuum sintering. For example, in the case that the sintering is made by a vacuum sintering, the temperature is raised to a sintering temperature in the range of about 800 to 1080° C. with a prescribed temperature rising rate, and then, this temperature is kept for about 0.1 to 2 hours. During this period, the vacuum sintering is carried out wherein the degree of vacuum is 5 Pa or less, while preferably 10⁻² Pa or less. Thereafter, the shaped body 40 is cooled down, and again subjected to a heat treatment in the temperature range of 300 to 1000° C. for two hours. As a result of the sintering, a sintered body is produced.

On the other hand, the pressure sintering may include a hot pressure sintering, a hot isostatic pressure (HIP) sintering, an ultrahigh pressure synthesis sintering, a gas pressure sintering, and a spark plasma (SPS) sintering. However, in order to suppress grain growth of the magnet particles during the sintering and also to suppress warpage to be formed in the magnet after sintering, it is preferable to adopt the spark plasma sintering which is a uniaxial pressure sintering in which a pressure is uniaxially applied and also in which sintering is carried out by an electric current sintering. Meanwhile, in the case that the sintering is carried out by the SPS sintering, preferably, the pressure value is set, for example, in the range of 0.01 to 100 MPa, and the temperature is raised to about 940° C. at the rate of 10° C./minute under a vacuum atmosphere with the pressure of not higher than several Pa, and then kept there for five minutes. The shaped body 40 is then cooled down, and again subjected to a heat treatment in the temperature range of 300 to 1000° C. for two hours. As a result of the sintering, a sintered body is produced.

Meanwhile, when the polar anisotropic ring magnet that is illustrated in FIG. 1 and FIG. 2 is produced, a plurality of the sintered bodies is fabricated in an annular ring shape and then fixed with each other by a resin or the like, which is further followed by magnetization and so forth to produce a permanent magnet 1. Meanwhile, an embodiment that the shaped bodies 40 before the sintering are fabricated in the annular ring shape to form a ring shape followed by sintering thereof may also be allowed. On the other hand, in the case that the sintered body is the shape of a final product, the permanent magnet 1 can be produced by carrying out magnetization and so forth to the sintered body.

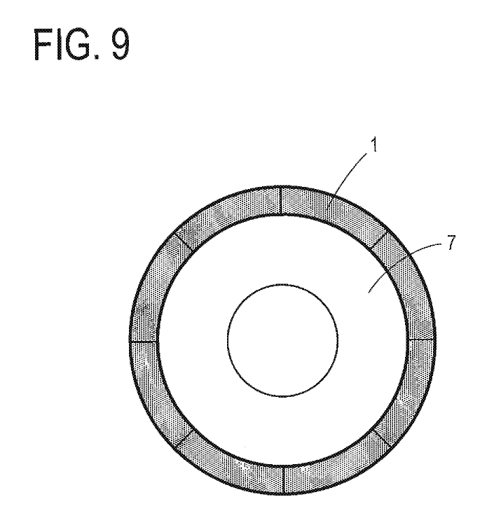

Also, in the case that an SPM motor is manufactured by using the permanent magnet 1 thus produced, a plurality of the sintered bodies which are produced by the manufacturing process depicted in FIG. 4 is disposed on a surface of a rotor 50 in the annular ring shape as depicted in FIG. 9, which is then followed by magnetization along the C-axis so as to make a polar anisotropy. As a result, the SPM motor having the polar anisotropic permanent magnet 1 disposed on a surface of the rotor 50 can be produced. Meanwhile, the permanent magnet 1 is magnetized by using, for example, a magnetizing coil, a magnetizing yoke, a condenser-type magnetizing power source apparatus, or the like.

Thereafter, members other than the rotor 50, such as a shaft, a stator, and so forth are fabricated to produce the SPM motor.

As explained above, in the permanent magnet 1 and the manufacturing method of the permanent magnet 1 according to the present embodiment, a raw material magnet is milled to magnet powder, and the magnet powder thus milled is mixed with a binder to form the compound 12. Then, the compound 12 thus formed is molded by a hot-melt molding to the green sheet 14 in the shape of a sheet onto the supporting substrate 13. Thereafter, a magnetic field is applied to the green sheet 14 thus molded to carry out the magnetic field orientation. Further, a plurality of the green sheets 14 subjected to the magnetic field orientation is laminated and fixed under a deformed state thereof and the plurality of the green sheets thus fixed is cut for shaping to a prescribed shape, which is then followed by sintering to produce the permanent magnet 1. As a result, by appropriately setting a lamination embodiment of the green sheet or a cutting embodiment of the green sheet laminated, the permanent magnet with various shapes having the axis of easy magnetization aligned in an arbitrary direction can be readily produced. For example, even in the case that the anisotropic magnet whose axis of easy magnetization needs to be aligned in a complicate shape such as those of a polar anisotropic magnet is produced, the magnetic field orientation process can be made simple. In addition, because the green sheet molding is used, the magnet particles move less rotationally after orientation as compared with the case of using powder compaction molding or the like, so that the degree of orientation can be improved as well.

In addition, because the green sheet molding can utilize the number of current turns, a high magnetic field strength during the time of the magnetic field orientation process can be secured; and in addition, because a magnetic field can be applied for a long period of time in a static magnetic field, the permanent magnet realizing a high degree of orientation with a low variation can be produced. Further, if the orientation direction is processed after orientation, orientation with a high orientation and a low variation can be secured.

In addition, realization of a high orientation with a low variation can contribute to reduction in the contraction variation due to sintering. That is, uniformity of the product shape after sintering can be secured. As a result, a burden of an outer shape processing after sintering can be lowered, which contributes, especially in the polar anisotropic ring magnet, to securing of a single sinusoidal variation of the magnet flux density. In addition, a significant improvement of stability in mass production can be expected.

In addition, because the binder includes a thermoplastic resin and a residual matter of the green sheet generated in the cutting process of the green sheet for shaping to a prescribed shape is heated so as to be reused to the compound 12, even in the case that a plurality of the laminated green sheets is subjected to the cutting process to a complicate shape, the residual matter generated by the cutting can be regenerated as a part of the green sheet, and therefore, decrease in a yield rate can be prevented from occurring.

In addition, by laminating the green sheets under a state curved in an arc-like shape, a sintered body whose axis of easy magnetization is aligned along the arc can be readily produced.

In addition, by disposing a plurality of the sintered bodies or of the shaped bodies in an annular ring shape, a polar anisotropic ring magnet whose axis of easy magnetization is orientated for a polar anisotropy can be readily formed. In addition, a magnetic flux density distribution with a sinusoidal shape more ideal than ever can be realized.

In addition, according to the SPM motor in which the above-described permanent magnet is disposed on a surface of the rotor, increase in torque and efficiency with decrease in size and torque ripple more than ever can be realized in the motor.

Meanwhile, the present invention is not limited to the examples described above; and thus, it is a matter of course that various improvements and modifications can be made, provided that the scope thereof does not deviate from the gist of the present invention.

For example, milling conditions of the magnet powder, kneading conditions, the magnetic field orientation process, laminating conditions, cutting conditions, calcining conditions, sintering conditions, and the like are not limited to the conditions described in the examples described above. For example, in the examples described above, a magnet raw material is milled by a wet milling using a bead mill; however, milling by a dry milling using a jet mill may also be allowed. In addition, in the examples described above, the green sheet is molded by a slot-die method; however, the green sheet may also be molded by using other method (for example, a calendar roll method, a comma coating method, an extrusion molding method, an injection molding method, a die molding method, a doctor blade method, and the like). However, it is preferable to use a method with which a compound in a fluid state can be molded onto a substrate with high accuracy. In addition, the atmosphere in the calcination process may be other than the hydrogen atmosphere (for example, a nitrogen atmosphere, a He atmosphere, an Ar atmosphere, or the like), provided that it is a non-oxidizing atmosphere. In addition, the calcination process may be omitted. In such a case, the decarbonization is carried out in the course of the sintering process.

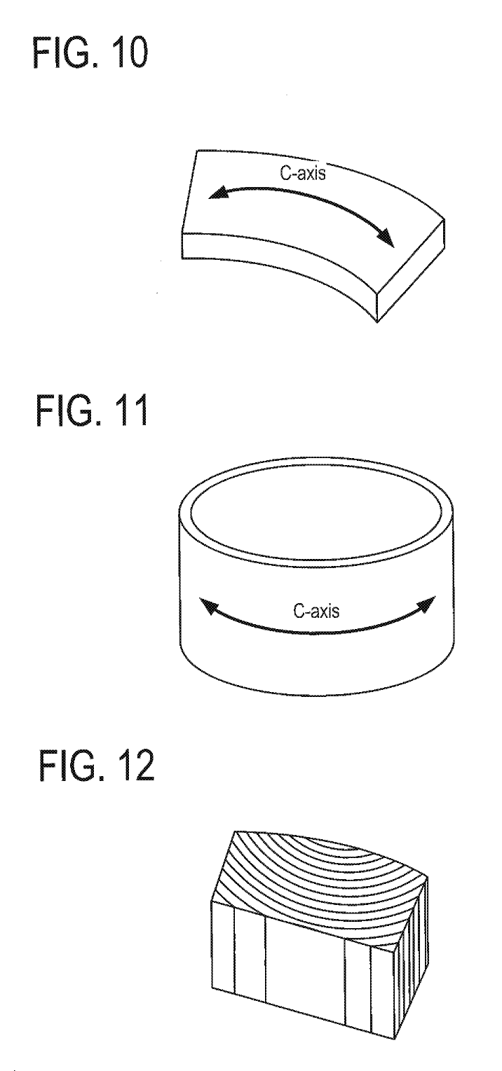

Also, in the examples described above, the deformation direction of the green sheet is the thickness direction; however, the deformation direction may be the in-plane direction. As a result, for example, as depicted in FIG. 10, a permanent magnet in the shape of a thin film in which the axis of easy magnetization is arranged to be curved to the in-plane direction of the green sheet may also be produced. Further, as depicted in FIG. 11, by deforming the green sheet to the shape of a cylinder, a permanent magnet in the shape of a cylinder in which the axis of easy magnetization is aligned in the tangential direction may also be produced. Further, a permanent magnet in the shape of a wave may also be produced. In the examples described above, the shaped body 40 is formed by cutting the green sheets after having been laminated for shaping; however, in the case of producing the permanent magnet in the shape of a thin film as illustrated in FIG. 10 and FIG. 11, the shaped body may also be formed from one piece of the green sheet without performing the lamination process.

Further, in the examples described above, in order to produce the polar anisotropic ring magnet, a fan-like shape (segment type) is formed by cutting the laminated green sheet; however, the shape to be formed may be changed variously in accordance with the use thereof. For example, illustrative example of the shape may include a semicylinder shape, a trapezoid shape, and a rectangular shape, as depicted in FIG. 12. By so doing, the permanent magnet to be accommodated in a slot (housing portion) formed in an IPM motor and so forth may also be produced.

In the examples described above, the polar anisotropic ring magnet is produced; however, a radial anisotropic ring magnet may also be produced by arbitrarily changing the direction of the magnetic field and the lamination embodiment of the green sheet. For example, the radial anisotropic ring magnet may be produced by orientating the magnetic field in the direction perpendicular to the green sheet and then laminating the green sheets in a baumkuchen-like shape along the arc of the ring.

In the examples described above, the calcination is carried out in a hydrogen atmosphere or in a mixed gas atmosphere of hydrogen and an inert gas after molding the magnet powder; however, an embodiment may also be allowed that the calcination process is carried out for the magnet powder before molding, then the magnet powder thus calcined is molded to a shaped body, and thereafter the sintering is carried out to produce the permanent magnet. When the embodiment as described above is employed, because the calcination is carried out for the magnet particle in the form of powder, the surface area of the magnet to be calcined can be made larger as compared with the case that the calcination is carried out for the magnet particle after molding. That is, the carbons in the calcined body can be reduced more surely. However, because the binder is thermally decomposed by the calcination process, the calcination process is preferably carried out after molding.

Further, in the examples described above, the heating process and the magnetic field orientation process of the green sheet 14 are simultaneously carried out; however, the magnetic field orientation process may be carried out after the heating process and before the green sheet 14 is solidified. Further, in the case that the magnetic field orientation is carried out before the coated green sheet 14 is solidified (that is, the green sheet 14 is in a softened state even without carrying out the heating process), the heating process may be omitted.

Further, in the examples described above, the slot-die coating process, the heating process, and the magnetic field orientation process are consecutively carried out in a series of processes. However, an embodiment that these processes are not carried out in the consecutive processes may also be allowed. Alternatively, an embodiment may also be allowed that the processes are divided into two parts, the first part up to the coating process and the second part from the heating process and the processes that follow, and each of the two parts is carried out consecutively. In such a case, an embodiment may be possible that the green sheet 14 having been coated is cut at a prescribed length, which is followed by heating the green sheet 14 in a stationary state and then the magnetic field orientation by applying the magnetic field.

Description of the present invention has been given by taking the example of the Nd—Fe—B-based magnet. However, other kinds of magnet may be used as well (for example, samarium-based cobalt magnet, alnico magnet, and ferrite magnet). Further, in the alloy composition of the magnet in the present invention, the proportion of the Nd component is larger than that in the stoichiometric composition. However, also the proportion of the Nd component may be the same as that in the stoichiometric composition.

### DESCRIPTION OF REFERENCE NUMERALS AND SIGNS

1 permanent magnet
2 sintered member
11 jet mill
12 compound
13 supporting substrate
14 green sheet
15 slot die
25 solenoid
26 hot plate
37 heating device
40 shaped body

1. A permanent magnet, manufactured by a method comprising:
milling a magnet raw material into magnet powder;
preparing a mixture of the magnet powder thus milled with a binder;
molding the mixture to a shape of a sheet thereby forming a green sheet;
carrying out magnetic field orientation to the green sheet by applying a magnetic field;
with laminating and fixing a plurality of the magnetically orientated green sheets under a deformed state thereof, cutting the plurality of the green sheets thus fixed for shaping to a prescribed shape; and
sintering the green sheet thus shaped to a prescribed shape by keeping at a sintering temperature.

2. The permanent magnet according to claim 1, wherein
the binder comprises a thermoplastic resin, and
a residual matter of the green sheet generated by cutting the green sheet for shaping to a prescribed shape is heated thereby reusing the residual matter for the mixture.

3. The permanent magnet according to claim 1, wherein
in the magnetic field orientation process, orientation is made in an in-plane direction of the green sheet, and
in the cutting process of the green sheet for shaping to a prescribed shape, the fixing is made such that the plurality of the magnetically orientated green sheets are laminated under a curved state thereof in such a way that a cross section of the green sheet in a thickness direction may be an arc-like shape.

4. The permanent magnet according to claim 3, wherein
the prescribed shape is a fan-like shape, and
a plurality of the sintered bodies obtained by sintering in the sintering process or a plurality of the shaped bodies before sintering in the sintering process is arranged in an annular ring shape thereby forming a polar anisotropic ring magnet whose axis of easy magnetization is orientated for a polar anisotropy.

5. An SPM motor, wherein the permanent magnet according to claim 1 is disposed on a surface of a rotor.

6. A method for manufacturing a permanent magnet, wherein the method comprises:
milling a magnet raw material into magnet powder;
preparing a mixture of the magnet powder thus milled with a binder;
molding the mixture to a shape of a sheet thereby forming a green sheet;
carrying out magnetic field orientation to the green sheet by applying a magnetic field;
with laminating and fixing a plurality of the magnetically orientated green sheets under a deformed state thereof, cutting the plurality of the green sheets thus fixed for shaping to a prescribed shape; and
sintering the green sheet thus shaped to a prescribed shape by keeping at a sintering temperature.

7. The method for manufacturing a permanent magnet according to claim 6, wherein
the binder comprises a thermoplastic resin, and
a residual matter of the green sheet generated by cutting the green sheet for shaping to a prescribed shape is heated thereby reusing the residual matter for the mixture.

8. The method for manufacturing a permanent magnet according to claim 6, wherein
in the magnetic field orientation process, orientation is made in an in-plane direction of the green sheet, and
in the cutting process of the green sheet for shaping to a prescribed shape, the fixing is made such that the plurality of the magnetically orientated green sheets are laminated under a curved state thereof in such a way that a cross section of the green sheet in a thickness direction may be an arc-like shape.

9. The method for manufacturing a permanent magnet according to claim 8, wherein the prescribed shape is a fan-like shape, and
a plurality of the sintered bodies obtained by sintering in the sintering process or a plurality of the shaped bodies before sintering in the sintering process is arranged in an annular ring shape thereby forming a polar anisotropic ring magnet whose axis of easy magnetization is orientated for a polar anisotropy.

10. A method for manufacturing an SPM motor, wherein the SPM motor is manufactured by disposing on a surface of a rotor the permanent magnet which is manufactured by the method according to claim 6.
